(19) United States
(12) Patent Application Publication
(10) Pub. No.: US 2026/0007098 A1
(43) Pub. Date: Jan. 8, 2026

(54) SELF-PROPELLED HARVESTER

(71) Applicant: CLAAS Selbstfahrende Erntemaschinen GmbH, Harsewinkel (DE)

(72) Inventors: Dennis Neitemeier, Lippetal (DE); Sven Carsten Belau, Gütersloh (DE); Ingo Bönig, Gütersloh (DE); Markus Brune, Harsewinkel (DE); Daniel Titkemeier, Osnabrück (DE); Matthis Dirksen, Warendorf (DE)

(73) Assignee: CLAAS Selbstfahrende Erntemaschinen GmbH, Harsewinkel (DE)

(21) Appl. No.: 19/257,782

(22) Filed: Jul. 2, 2025

(30) Foreign Application Priority Data
Jul. 2, 2024 (DE) 10 2024 118 780.8

(51) Int. Cl. A01D 41/127; A01D 41/14

(52) U.S. Cl. CPC A01D 41/1277; A01D 41/141

(57) ABSTRACT

A self-propelled harvester and a method for operating a self-propelled harvester. The harvester comprises a front attachment for picking up harvested material, work units for processing the picked-up harvested material, a transfer device for discharging the processed harvested material, a camera system for capturing images of a flow of harvested material passing through the harvester, and an image evaluation device for evaluating the images. The image evaluation device is configured to analyze the images of the flow of harvested material for a proportion of inorganic contaminants contained in the flow of harvested material using a machine learning algorithm when the harvested material is collected by the attachment.

### CROSS REFERENCE TO RELATED APPLICATION

This application claims priority under 35 U.S.C. § 119 to German Patent Application No. DE 10 2024 118 780.8 filed Jul. 2, 2024, the entire disclosure of which is hereby incorporated by reference herein. U.S. application Ser. No. ______ (attorney docket no. 15191-25011A (P05858/8)) is incorporated by reference herein in its entirety.

### TECHNICAL FIELD

The present invention relates to a self-propelled harvester and to a method for analyzing ingredients in the harvested material.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

US Patent Application Publication No. 2022/0284698 A1, incorporated by reference herein in its entirety, discloses a self-propelled harvester. Using a camera system, images of a flow of harvested material passing through the harvester are recorded and evaluated by an image evaluation device. The evaluation may be based on the determination of particle lengths of particles contained in the images.

US Patent Application Publication No. 2012/0185140 A1, incorporated by reference herein in its entirety, discloses that contents of the harvested material in the flow of harvested material, such as protein content or starch, may be determined using near-infrared spectroscopy.

### BRIEF DESCRIPTION OF THE DRAWINGS

The present application is further described in the detailed description which follows, in reference to the noted drawings by way of non-limiting examples of exemplary embodiment, in which like reference numerals represent similar parts throughout the several views of the drawings, and wherein:

FIG. 1 illustrates a schematic example of a self-propelled harvester.

FIG. 2 illustrates an exemplary schematic representation of an image evaluation device.

FIG. 3 illustrates another exemplary schematic representation of the image evaluation device.

FIG. 4 illustrates an example of an image segmented by a neural network by means of the hybrid algorithm according to FIG. 3.

### DETAILED DESCRIPTION

As discussed in the background, particle lengths in the harvested material may be determined. Further, contents of the harvested material may be determined using near-infrared spectroscopy. When the harvested material is collected by the front attachment, additional contaminants adhering to the harvested material or, if the distance to the field soil is too small, contaminants picked up by the front attachment itself may enter the flow of harvested material passing through the harvester. The degree or amount of contamination may detrimentally affect the further use of the processed harvested material. For example, when harvesting green fodder, contaminants contained therein may cause noxious fermentation of the silage or may cause disease in the animals to which the green fodder is fed. This may necessarily result in financial losses.

The crude ash content may be used as an indicator for the degree of contamination of the harvested material. The crude ash content may not be determined directly by near-infrared spectroscopy based on measured values for crude ash, but may be estimated by correlation with other measured variables. However, the estimate may be imprecise. Alternatively, the crude ash content may be determined in the laboratory by ashing the harvested material. However, such a procedure cannot be carried out by a harvester.

Thus, in one or some embodiments, a self-propelled harvesting machine is disclosed which enables the degree of contamination of the flow of harvested material to be determined while the harvesting machine is in operation, such as in ongoing harvesting mode.

Further, in one or some embodiments, a method for analyzing contents in the harvested material is disclosed wherein images of the flow of harvested material are analyzed by the image evaluation device for a proportion of, such as inorganic, contaminants contained in the flow of harvested material recorded while being collected by the front attachment using a machine learning algorithm. One or both of the front attachment or the work units of the self-propelled harvester may be actuated or controlled depending on the determined degree of contamination.

In one or some embodiments, a self-propelled harvester is disclosed that comprises a front attachment configured to pick up or collect harvested material, one or more work units configured to process the picked-up harvested material, a transfer device configured to discharge the processed harvested material, a camera system configured to capture images of a flow of harvested material passing through the harvester, and an image evaluation device configured to evaluate the images. In one or some embodiments, the image evaluation device is configured to analyze, using a machine learning algorithm, the image(s) of the flow of harvested material for a proportion of in particular inorganic contaminants contained in the flow of harvested material when or whereby the harvested material is collected by the front attachment. In turn, a control device, such as the driver assistance system, may control one or both of the front attachment or the one or more work units based on the proportion of inorganic contaminants contained in the flow of harvested material (e.g., based on the inorganic contaminants themselves, or an indication or something derived from the inorganic contaminants).

In one or some embodiments, inorganic contamination of the harvested material may be caused, among other things, by the settings of work machines and harvesters that are used in the preparation and performance of the harvesting process. In particular, poorly adjusted work machines and harvesters may contribute to an increased input of inorganic contaminants into the harvested material to be collected. Other influencing factors may be environmental influences such as heavy rainfall or drought, which may lead to increased contamination of the harvested material.

The self-propelled harvester may make it possible to automatically analyze the proportion of a part of the flow harvested material, such as inorganic contaminants contained in the flow of harvested material, using the machine learning algorithm and using the image evaluation device, with the analysis being performed at least partly during ongoing harvesting operation (e.g., the automatic analysis is performed at least partly during the ongoing harvesting operation, such as the crop is being harvested). This may represent the potential of economically qualifying and/or quantifying a degree of contamination of the harvested material. In one or some embodiments, the analysis may be performed in real time.

In particular, the image evaluation device may comprise a computing unit and a memory unit, wherein a plurality of contamination classes may be saved in the memory unit, which may define different degrees of contamination of the harvested material, which may be dependent on the mass content of the inorganic contaminants in the dry mass of the harvested material. Impurities, such as inorganic contaminants, may comprise sand, earthy components such as humus soil or other soil components. In this case, a distinction may be made between five degrees of contamination, which may result from the ratio of the mass content of inorganic contaminants to the dry mass of the harvested material. In particular, using the machine learning algorithm, the sand content, the proportion of earthy components and/or another indicator representative of soil material as a contamination in the harvested material may be determined in order to qualify or determine the degree of contamination (e.g., on a scale of a plurality of degrees of contamination). A contamination class may be assigned to each degree of contamination.

In one or some embodiments, the machine learning algorithm may comprise at least one trainable neural network for analyzing the images

In particular, the at least one neural network may use an EfficientNet, such as EfficientNetB0, as the basis as an architecture and scaling method for convolutional neural networks. Neural convolutional networks or convolutional neural networks (CNN), such as EfficientNet, may achieve particularly good results in image processing. EfficientNet may scale all dimensions of depth/width/resolution uniformly with a composite coefficient. In contrast to the conventional practice of the use of a convolutional neural network in which these factors are scaled arbitrarily, the EfficientNet scaling method scales the network width, depth and resolution uniformly with a series of fixed scaling coefficients. The composite scaling method may be justified in that with a larger input image, the network may need more layers to enlarge the receptive field and more channels to record more fine-grained patterns on the larger image.

In one or some embodiments, the at least one neural network may use a direct algorithm to analyze the one or more images received from the camera system, with the at least one neural network: inputting the one or more images in raw data format; subjecting the one or more images directly to classification, and determining at least one contaminant class, from a plurality of potential contamination classes, as an output variable. In one or some embodiments, the direct algorithm used by the neural network directly processes the images of the camera system (e.g., without preprocessing by semantic segmentation), in order to perform the classification directly with which one of the contamination classes (from the plurality of potential contamination classes) is determined as the output variable.

In one or some embodiments, the at least one neural network may use a hybrid algorithm to analyze the images received by the camera system, which may: input the one or more images in raw data format; subject the images to semantic segmentation; and feed one or more features extracted from the pixel-by-pixel segmented images as output variables to a second neural network. The second neural network may: input the one or more features extracted from the pixel-by-pixel segmented images; and determine at least one contamination class (from the plurality of potential contamination classes) from the one or more features extracted, with the second neural network outputting the determined at least one contamination class as an output variable.

For this purpose, the at least one neural network may segment the images received from the camera system pixel-by-pixel in that a class may be assigned to each pixel, which may be defined as a property saved in the memory unit.

Various property classes are contemplated, such as the property “soil” as one class, and the property “harvested material” as another class. In one or some embodiments, a reduction to just two properties may simplify the process of semantic segmentation by the at least one neural network.

In particular, features to be extracted from the feature group may comprise any one, any combination, or all of: segmentation ratio; number of polygons; average polygon size; standard deviation of the polygon size distribution; smallest polygon size; and largest polygon size. The feature(s) extracted may be saved in the memory unit. For this purpose, polygons in the pixel-by-pixel segmented image that contain segmented pixels of the “soil” class may be determined using a contour search algorithm.

In one or some embodiments, the second neural network may be a neural network with an input layer, a hidden layer and an output layer. In particular, the at least one neural network may evaluate at least three consecutively received images of the flow of harvested material for the determination of the contamination class, wherein the results are output as a weighted average value. This may allow a statistically robust output value to be generated, regardless of whether the direct algorithm or the hybrid algorithm is used.

Furthermore, one of the at least three consecutive images of the flow of harvested material for which the contamination class is to be determined may be selected, wherein the selected image may have a higher weighting than the at least two other images when averaging. By way of example, the selected image may be weighted with 40%, and the other two images may be weighted with 30%. In one or some embodiments, the selected image is the second image of the three images taken sequentially in chronological order.

In one or some embodiments, the flow of harvested material is a green forage flow of harvested material. This may be corn, grass or whole plant silage as green forage which is picked up or collected by the harvester.

In one or some embodiments, the harvester may be a forage harvester with a transfer device designed as a discharge chute, wherein the camera system comprises a camera arranged or positioned on the discharge chute, which may be configured to detect the flow of harvested material flowing through the discharge chute.

In one or some embodiments, a method is disclosed for analyzing contents in the harvested material, which may be collected by a self-propelled harvester as herein. For example, the self-propelled harvester may comprise a front attachment, one or more work units to process the contents collected by the harvester, and a transfer device to discharge the contents. One or more images of a flow of harvested material passing through the harvester may be captured or generated by a camera system arranged or positioned on the transfer device. Further, the one or more images may be evaluated by an image evaluation device (using a machine learning algorithm), wherein the images of the flow of harvested material are analyzed by the image evaluation device for a proportion of inorganic contaminants contained in the flow of harvested material recorded while being collected by the front attachment. Responsive to the determination of the proportion of inorganic contaminants, one or both of the front attachment or the one or more work units of the self-propelled harvester may be automatically controlled (e.g., actuated depending on the determined degree of contamination).

To reduce contaminants in the picked up harvested material, the height-adjustable front attachment arranged or positioned on a feed device may be controlled in that the distance to the field soil is modified, and/or the contact pressure on the field soil is adjusted. Additionally or alternatively, a transverse and/or longitudinal adjustment of the front attachment relative to the ground may be performed. Alternatively or additionally, in order to minimize picking up contaminants, a drive speed of at least one material-conveying component of the front attachment may be adjusted. The type and design of a material conveying component may depend on the design of the front attachment and may correspondingly vary.

To control the front attachment, the harvester may have a control unit that is in communication with (e.g., data-linked to) the image analysis device. The image evaluation device may transmit to the control unit the degree of contamination determined by the analysis, which, depending on the degree of contamination, performs one or more of the aforementioned measures to control the front attachment.

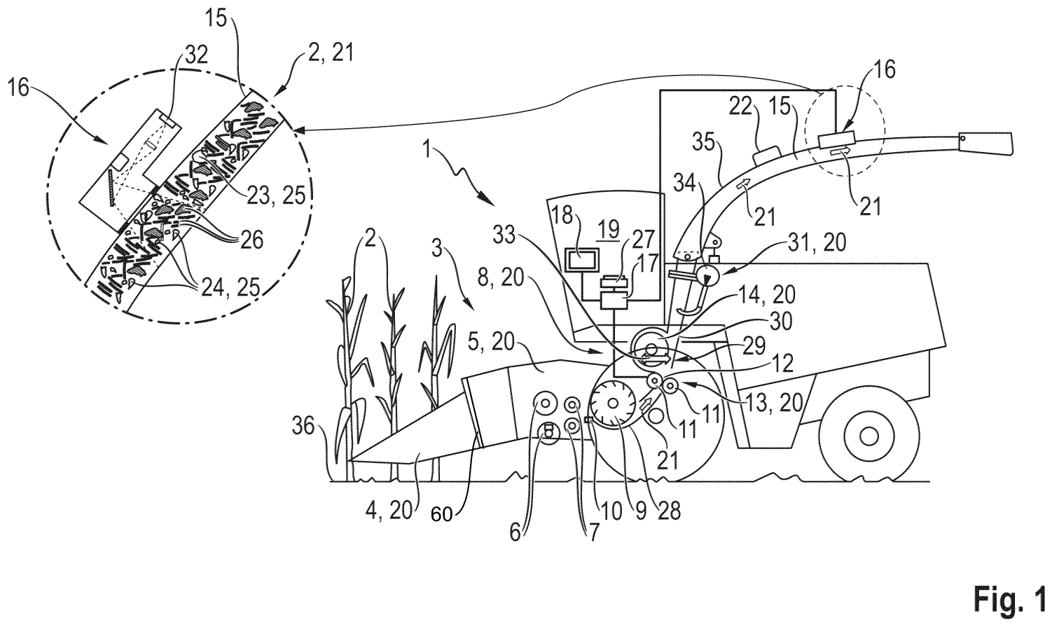

Referring to the figures, FIG. 1 schematically illustrates a self-propelled harvester 1, which may comprise a forage harvester. Examples of forage harvesters are disclosed in US Patent Application Publication No. 2024/0196796 A1, US Patent Application Publication No. 2024/0237580 A1, US Patent Application Publication No. 2025/0072326 A1, each of which are incorporated by reference herein in their entirety. FIG. 1 illustrates harvesting and collecting a crop of harvested material 2, such as corn plants, grass or whole plant silage as green fodder, in a field. Pick-up device 3 of the harvester 1 comprises, in a known manner, an attachment 4 that may be exchanged to adapt to the harvested material 2 to be harvested or collected and a feed device 5 with several pairs of rollers 6, 7 (e.g., prepress or preconditioning rollers), which may take the harvested material 2 from the front attachment 4 in order to feed it to a chopping device 8. In one or some embodiments, the attachment 4 may be mounted directly to the harvester 1 (via a mounting device 60 on harvester 1) or via an adapter that connects the harvester 1 to the attachment 4. See US Patent Application Publication No. 2024/0196796 A1. As one example, the mounting device 60 may include any one, any combination, or all of bolts, clamps, or fasteners that may be resident on one of the mounting device 60 with mating attachments (e.g., holes, clamps, or the like) resident on the attachment 4. The picked up or collected harvested material 2 then passes through the harvester 1 as a flow of harvested material 21, illustrated by arrows.

The front attachment 4 may, for example, be designed as a corn attachment to harvest stalky crops 2 or as a pick-up which picks up crops 2, such as grass, deposited in swaths in the field. The front attachment 4 may also have a cutter bar with a feed auger to mow and pick up grass in a single pass.

The chopping device 8 may comprise a rotationally driven cutterhead 9, a shear bar 10 over which the harvested material 2 is pushed by the adjacent pair of rollers 7 of the feed device 5 in order to be chopped by the interaction of the shear bar 10 with the cutterhead 9. Using an actuator, a distance of a drum bottom 28 (or drum base), which may partially surround the cutterhead 9 in the circumferential direction, may be adjusted.

An optional secondary crushing device 13, also known as a corn cracker, with a pair of conditioning or cracker rollers 11 may be arranged or positioned downstream from the chopping device 8, which may be removed and/or swung out in the ejection channel 29 (or discharge channel). The conditioning rollers 11 delimit a gap 12 of adjustable width and rotate at different speeds in order to crush grains contained in the material stream passing through the gap 12.

A post-accelerator 14 may give the shredded flow of harvested material 21 conditioned in the optional secondary crushing device 13 the necessary speed to pass through a transfer device that comprises a discharge chute 15 and to be transferred into an accompanying vehicle (not shown). The post-accelerator 14 may be arranged or positioned at a variable distance from the opposite wall 30 of the ejection channel 29. The post-accelerator 14 may be moved closer to or further away from the wall 30 in the horizontal direction, which is illustrated by arrow 33.

A silage additive metering device 31 may be arranged or positioned downstream from the post-accelerator 14, which may introduce a liquid into the ejection channel 29 using a controllable or actuatable feed pump 34 with a variable delivery volume.

In one or some embodiments, the discharge chute 15 has an essentially rectangular cross-section along its lengthwise extension. The discharge chute 15 may have a continuous closed upper side 35 and a partially open underside. Side walls may be arranged or positioned orthogonally to the upper side 35 of the discharge chute 15, which may laterally delimit and guide the flow of harvested material 21 conveyed through the discharge chute 15.

At least one camera system 16 is arranged or positioned on the discharge chute 15 in order to generate images 41 of the flow of harvested material 21 conveyed through the discharge chute 15. Furthermore, a sensor, such as an NIR sensor 22, may be arranged or positioned on the discharge chute 15. The NIR sensor 22 may be used to generate data, which when analyzed, may determine the harvested material properties. In one or some embodiments, the NIR sensor 22 may be positioned here upstream from the camera system 16 on the upper side 35 of the discharge chute 15.

Thus, work units 20 of the harvester 1 may comprise any one, any combination, or all of: the front attachment 4; the intake device 5; the chopping device 8; the secondary crushing device 13; the post-accelerator 14; or the silage additive metering device 31 and their given components. The work units 20 may be used for harvesting or picking up the harvested material 2 of a field crop and/or for processing the harvested material 2 as part of the harvesting process.

The flow of harvested material 21 processed by the work units 20 of the harvester 1 may have a different composition depending on the type of harvested material. For example, in the case of corn as the harvested material type, the stream of harvested material 21 basically contains whole grains 23 and comminuted grains 24 as grain components 25 as well as non-grain components 26 such as stalks, leaves and the like. With grass as the type of harvested material, the stream of harvested material 21 basically contains only cut grass as harvested material 2.

In addition, contaminants adhering to the harvested material 2 may pass through the front attachment 4 with the picked up harvested material 2 or, if the distance to the field soil 36 is too small, contaminants picked up by the front attachment 4 itself may enter the flow of harvested material 21 passing through the harvester 1. Contaminants adhering to the harvested material 2 may be caused, among other things, by a previous processing operation in the field (e.g., an operation that was performed prior to the forage harvester 1 even collecting the harvested material 2). In the case of grass harvesting, examples of this may include mowing, turning and swathing.

In one or some embodiments, at least a part of at least one camera system 16 may be arranged or positioned on the discharge chute 15. For example, the at least one camera system 16 may have at least one camera 32 for recording images 41 of the harvested material 2 contained in the flow of harvested material 21. The camera 32 may be positioned on discharge chute 15. The camera 32 may comprise a multispectral camera which records the light with at least three distinguishable wavelength ranges. Alternatively, the camera 32 may comprise a hyperspectral camera. In particular, the camera 32 may record visible light and infrared light, such as near-infrared light, from different wavelength ranges.

The images 41 may be saved in raw data format. For example, the at least one camera 32 may record spatially resolved images 41. The term “spatially resolved” may mean that it is possible to distinguish details of the harvested material 2 and contaminants from one another using the images 41. The camera 32 therefore may have a sufficient number of pixels to enable an analysis of the images 41 by the image evaluation device 27, as will be explained. In a measurement routine, the camera system 16 (using the camera 32) may capture a plurality of images 41 of the harvested material 2 as well as the contaminants entrained in the flow of harvested material 21. This measurement routine may accordingly be performed during operation of the harvester 1.

In one or some embodiments, the image evaluation device 27 is in communication with (e.g., bi-directional communication) a driver assistance system 17, or may be designed as a component of the driver assistance system 17. The driver assistance system 17 may include a memory unit 39 for saving data and a computing device 40 for processing the data saved in the memory unit 39. The driver assistance system 17 may be connected to an input/output unit 18 (e.g., a touchscreen) in a driver's cab 19 of the harvester 1 in order to output evaluation results thereto. The driver assistance system 17 may be configured to control at least one actuator 58 (via wired and/or wireless communication 59) for adjusting, modifying or controlling one or more of the work units 20.

In one or some embodiments, the computing device 40 may comprise at least one processor and the memory unit 39 may comprise at least one memory (configured to store data, such as image(s), machine learning algorithm(s), neural network(s), and/or computer-executable instructions stored on the tangible memory). The driver assistance system 17 may further include at least one communication interface 57 (configured to communication with devices external to the driver assistance system 17, such as actuators 58, other electronic devices, or the like). The at least one processor and at least one memory may be in communication (e.g., wired and/or wirelessly) with one another. In one or some embodiments, the computing device 40 may comprise a microprocessor, controller, PLA, or the like. Similarly, the memory unit 39 may comprise any type of storage device (e.g., any type of memory, such as RAM, ROM, or a combination thereof). Though the computing device 40 and the memory unit 39 are depicted as separate elements, they may be part of a single machine, which includes a microprocessor (or other type of controller) and a memory. Alternatively, the computing device 40 may rely on the memory unit 39 for all of its memory needs. Still alternatively, the computing device 40 may rely on a database for some or all of its memory needs. The memory unit 39 may comprise a tangible computer-readable medium that include software that, when executed by the computing device 40 is configured to perform any one, any combination, or all of the functionality described herein. Further, the communication interface 57 may be configured to communicate (e.g., wired and/or wirelessly) with one or more electronic devices.

The computing device 40 and the memory unit 39 are merely one example of a computational configuration for the electronic devices discussed herein. Other types of computational configurations are contemplated. For example, all or parts of the implementations may be circuitry that includes a type of processor, including an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

The image evaluation device 27, using a machine learning algorithm, may be configured to analyze the images 41 of the flow of harvested material 21 for a proportion of inorganic contaminants contained in the flow of harvested material 21, which may have been collected by the front attachment.

The image evaluation device 27 comprises a computing unit 37 (e.g., similar to computing device 40 discussed above) and a memory unit 38 (e.g., similar to memory unit 39 discussed above). Alternatively, image evaluation device 27 may be part of the driver assistance system 17. A plurality of contamination classes may be saved in the memory unit 38, that define different degrees of contamination VG, which may be dependent on the mass content of inorganic contaminants, such as sand, earthy components such as humus soil, other soil components or the like, in the dry mass of the harvested material 2.

The following table shows an exemplary classification according to Resch et. al. 2013 “Bedeutung des Eisengehaltes als Indikator für die Futterverschmutzung von Grünlandfuttermitteln” [Importance of iron content as an indicator of forage contamination in grassland forage]. In addition to the iron content, the proportion of sand contained in the dry matter of harvested material 2 is listed as an indicator of forage contamination. Other indicators may be earthy components such as humus soil or other soil components. A contamination class may be assigned to each degree of contamination VG.

TABLE

| Contamination | Degree of | Iron | Sand content |
|---|---|---|---|
| class | contamination VG | [mg/kg DM] | [g/kg DM] |
| 1 | Clean | Under 400 | Under 13 |
| 2 | Light | 400 to 800 | 13 to 19 |
| 3 | Moderate | 800 to 1500 | 19 to 30 |
| 4 | Strong | 1500 to 3000 | 30 to 53 |
| 5 | Very strong | Over 3000 | Over 53 |

The machine learning algorithm may comprise at least one trainable neural network 42 configured to analyze the images 41 of the flow of harvested material 21. In one or some embodiments, the at least one neural network 42 uses as a basis an EfficientNet, in particular EfficientNetB0, as an architecture and scaling method for convolutional neural networks.

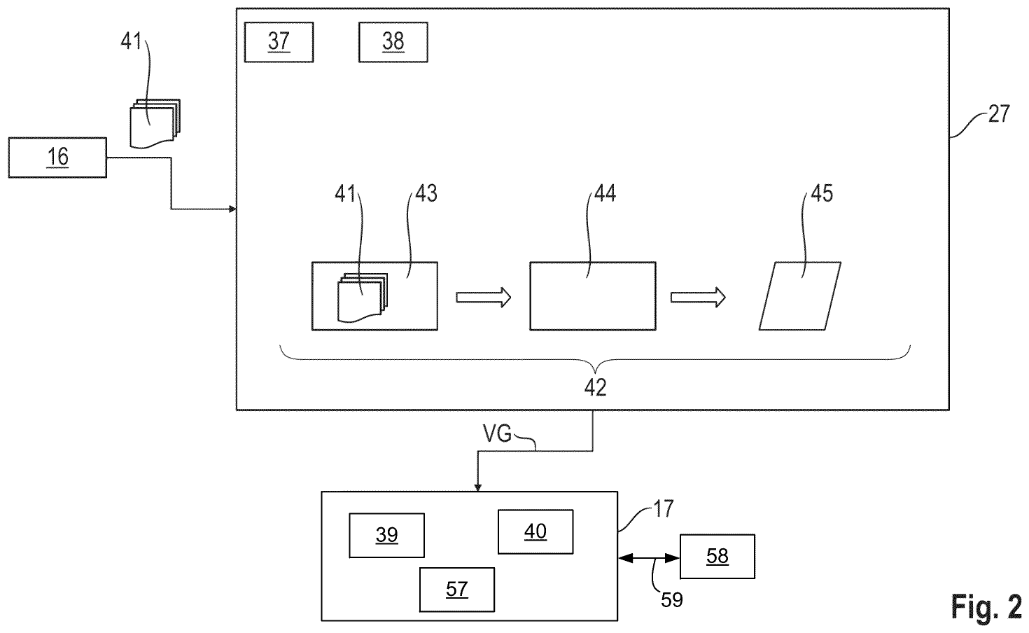

FIG. 2 illustrates an example of a schematic representation of the image analysis device 27. According to the embodiment of the image evaluation device 27 illustrated in FIG. 2, the at least one neural network 42 uses a direct algorithm for analyzing the images 41 received from the camera system 16, which uses the images 41 in raw data format as an input variable 43, which may be subjected directly (e.g., without an intermediate step for semantic segmentation) to classification by the at least one neural network 42 in a classification step 44 and determine one of the contamination classes saved in the memory unit 38 as an output variable 45.

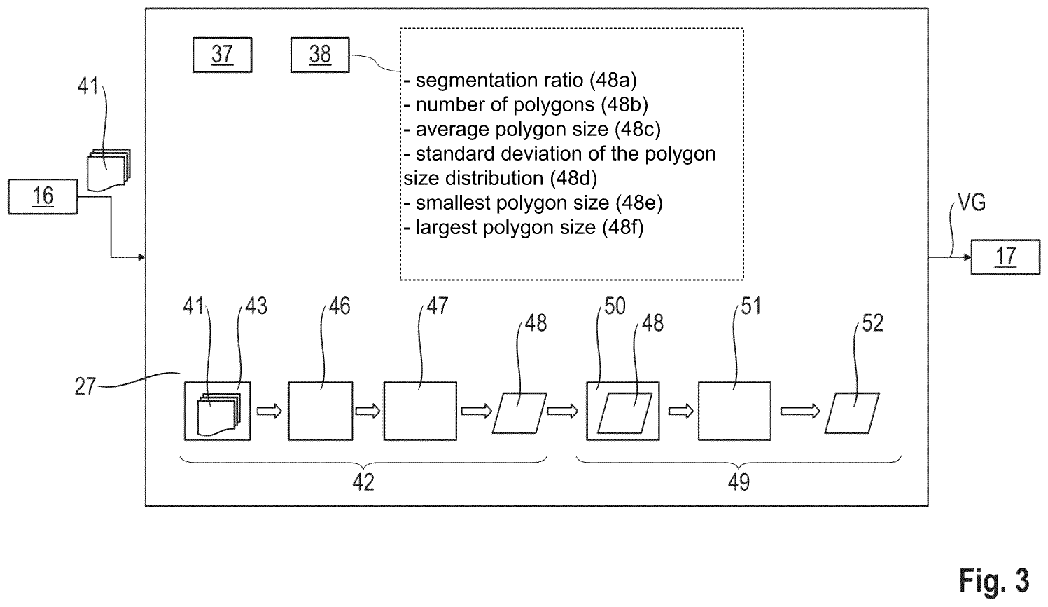

FIG. 3 illustrates a schematic representation of the image analysis device 27 according to an alternative embodiment. According to the alternative embodiment of the image evaluation device 27, the at least one neural network 42 uses a hybrid algorithm for analyzing the images 41 received from the camera system 16, which uses as an input variable 43 the images 41 received in raw data format which are subjected to a semantic segmentation by a segmentation model 46 by the neural network 42 and generates features 48 extracted from the pixel-wise segmented images 41a as an output variable. The features 48 of the neural network 42 generated as output variables may be fed to a second neural network 49 as input variables 50, which may determine one of the contamination classes (as potential contamination classes) saved in the memory unit 38 from the extracted features 48 in a classification step 51 as an output variable 52.

For this purpose, the neural network 42 segments the images 41 received from the camera system 16 pixel-by-pixel in that a class is assigned to each pixel 54, which may be defined as a property saved in the memory unit 38. For example, the property “soil” may be saved as one class 55, and the property “harvested material” may be saved as another class 56.

Extracted features 48 saved in the memory unit 38 may be from one or more features, such as any one, any combination, or all of the following feature group: segmentation ratio 48a; number of polygons 48b; average polygon size 48c; standard deviation of the polygon size distribution 48d; smallest polygon size 48e; and largest polygon size 48f. The polygons 53 may be determined for this purpose using a contour search algorithm 47, which may be executed by the neural network 42 in order to extract the features 48 therefrom from the aforementioned feature group.

The feature 48 “Segmentation ratio 48a” may describe the number of pixels 54 classified as “soil” in relation to the total number of pixels 54 in the pixel-wise segmented image 41a. The feature 48 “number of polygons 48b” may describe the number of areas classified as “soil”. The feature 48 “average polygon size 48c” may describe an average size of the polygons 53. The feature 48 “smallest polygon size 48e” may indicate the number of pixels 54 of the class 55 of the smallest determined polygon 53. The feature 48 “largest polygon size 48f” may indicate the number of pixels 54 of the class 55 of the largest determined polygon 53.

In one or some embodiments, the second neural network 49 may be a neural network with an input layer, hidden layer(s) (e.g., only one hidden layer), and an output layer. The second neural network 49 may be designed as a simple neural network for the sole process of classification.

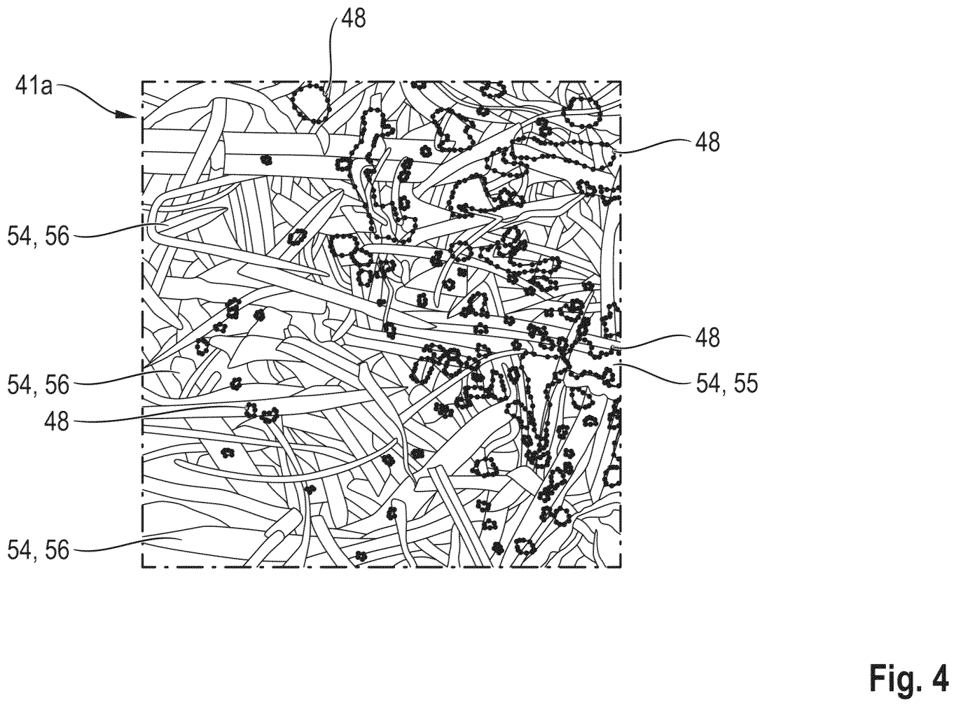

FIG. 4 illustrates an example of an image 41a segmented by the neural network 42 using the hybrid algorithm according to FIG. 3. The images 41 transmitted to the neural network 42 in raw data format as an input variable 43 may be segmented pixel-by-pixel by the segmentation model 46. Each segmented pixel 54 of the image 41a may be assigned either the class 55 with the property “soil” or the further class 56 with the property “crop”. The regions outlined in FIG. 4 may be contiguous areas of pixels 54 that have been assigned to class 55 with the property “soil”. Using the contour search algorithm 47, the polygons 53 may be determined based on the contiguous areas of pixels 54 that have been assigned to the class 55 with the property “soil”. The features 48 may be extracted from the determined polygons 53 as the output variable of the neural network 42.

The second neural network 49 may process the extracted features 48 as an input variable 50 in the classification step 51 and determine one of the contamination classes (saved in the memory unit 38) as an output variable 52.

The neural network 42 may be configured to evaluate at least three consecutively received images 41 of the flow of harvested material 21 to determine the contamination class, wherein the results may be output as a weighted average value. This may make it possible to generate a statistically robust output value for the output variable 45 or 52 (e.g., the assignment to one of the contamination classes listed in Table 1 and therefore to one of the degrees of contamination VG), irrespective of whether the direct algorithm, which may be executed by the neural network 42 alone, or the hybrid algorithm, which may be executed by the two neural networks 42 and 49, is used.

Furthermore, one of the at least three consecutive images 41 of the flow of harvested material 21 may be selected for which the contamination class is to be determined as the output variable 45 or 52, wherein the selected image 41 may have a higher weighting than the at least two other images 41 when averaging. For example, the selected image 41 may be weighted with 40% and the two other images 41 may be weighted with 30%. In one or some embodiments, the selected image 41 may be the second image of the three images 41 taken sequentially in chronological order.

The harvester 1 described above may be configured to perform the method for analyzing the contents in the harvested material 2. The harvested material 2 may be collected by the self-propelled harvester 1 with the front attachment 4, processed by the work units 20 of the harvester 1 and discharged by the discharge chute 15 of the transfer device. The images 41 of the flow of harvested material 21 passing through the harvester 1 may be captured by the camera system 16 arranged or positioned on the discharge chute 15 of the transfer device and evaluated by the image evaluation device 27. The proportion of inorganic contaminants contained in the flow of harvested material 21 may be analyzed using the machine learning algorithm using a direct or hybrid algorithm. The front attachment 4 and/or the work units 20 of the self-propelled harvester 1 may be automatically actuated (e.g., by the driver assistance system 17) depending on the degree of contamination VG that is automatically determined. For example, the driver assistance system 17 may be configured for this purpose, which may automatically receive the output variables 45 or 52 generated by the image analysis device 27 and may automatically generate one or more control signals therefrom for actuation (e.g., transmit the control signals via the communication interface 57 in order to control one or more of the work units 20, such as actuator(s) 58 of the work units 20).

Further, it is intended that the foregoing detailed description be understood as an illustration of selected forms that the invention may take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

### LIST OF REFERENCE NUMBERS

| | |
|---|---|
| 1 | Harvester |
| 2 | Harvested material |
| 3 | Pick-up device |
| 4 | Front attachment |
| 5 | Feed device |
| 6 | Roller pair |
| 7 | Roller pair |
| 8 | Chopping device |
| 9 | Cutterhead |
| 10 | Shear bar |
| 11 | Cracker roller |
| 12 | Gap |
| 13 | Secondary crushing device |
| 14 | Post-accelerator |
| 15 | Discharge chute |
| 16 | Camera system |
| 17 | Driver assistance system |
| 18 | Input/output unit |
| 19 | Driver's cab |
| 20 | Work unit |
| 21 | Harvested material flow |
| 22 | NIR sensor |
| 23 | Grains |
| 24 | Crushed grains |
| 25 | Grain components |
| 26 | Non-grain components |
| 27 | Image evaluation device |
| 28 | Drum bottom |
| 29 | Ejection channel |
| 30 | Wall |
| 31 | Silage additive metering device |
| 32 | Camera |
| 33 | Arrow |
| 34 | Delivery pump |
| 35 | Top side |
| 36 | Field soil |
| 37 | Computing unit |
| 38 | Memory unit |
| 39 | Memory |
| 40 | Computer device |
| 41 | Images |
| 41a | Segmented image |
| 42 | Neural network |
| 43 | Input variable |
| 44 | Classification step |
| 45 | Output variable |
| 46 | Segmenting model |
| 47 | Contour search algorithm |
| 48 | Feature |
| 48a | Segmentation ratio |
| 48b | Number of polygons |
| 48c | Average polygon size |
| 48d | Standard deviation of the polygon size distribution |
| 48e | Smallest polygon size |
| 48f | Largest polygon size |
| 49 | Second neural network |
| 50 | Input variable |
| 51 | Classification step |
| 52 | Output variable |
| 53 | Polygon |
| 54 | Pixel |
| 55 | Classified pixels |
| 56 | Classified pixels |
| 57 | Communication interface |
| 58 | Actuator |
| 59 | Communication |
| 60 | Mounting device |
| VG | Degree of contamination VG |

1. A self-propelled harvester comprising;
a mounting device configured to attach to a front attachment that is configured to collect harvested material;
one or more work units configured to process the harvested material that is collected;
a transfer device configured to discharge the harvested material that is processed;
a camera system configured to capture one or more images of a flow of the harvested material passing through the harvester;
an image evaluation device configured to evaluate the one or more images, wherein the image evaluation device is configured to analyze, using a machine learning algorithm, the one or more images of the flow of harvested material for a proportion of inorganic contaminants contained in the flow of harvested material collected by the front attachment; and
a driver assistance system configured to control, based on the proportion of inorganic contaminants contained in the flow of harvested material, one or both of the front attachment or the one or more work units.

2. The self-propelled harvester of claim 1, wherein the image evaluation device comprises a computing unit and a memory unit; and
wherein a plurality of contamination classes are saved in the memory unit and define different degrees of contamination which are dependent on mass content of the inorganic contaminants the harvested material.

3. The self-propelled harvester of claim 2, wherein the inorganic contaminants comprise one or more of sand or humus soil in dry mass of the harvested material.

4. The self-propelled harvester of claim 1, wherein the machine learning algorithm comprises at least one trainable neural network for analyzing the one or more images.

5. The self-propelled harvester of claim 4, wherein the at least one neural network is configured to use as a basis an EfficientNet as an architecture and scaling method for convolutional neural networks.

6. The self-propelled harvester of claim 4, wherein the at least one neural network is configured to use a direct algorithm for analyzing the one or more images received from the camera system;
wherein the at least one neural network is configured to:
use the one or more images in raw data format as an input variable, subject the one or more images in the raw data format directly to a classification; and
determine at least one class, from a plurality of contamination classes, as an output variable.

7. The self-propelled harvester of claim 4, wherein the at least one neural network is configured to use a hybrid algorithm for analyzing the one or more images received from the camera system;
wherein the at least one neural network is configured to input the one or more images in raw data format;
wherein the at least one neural network is configured to subject the one or more images to semantic segmentation in order to generate one or more pixel-by-pixel segmented images;
wherein the at least one neural network is configured to output one or more features extracted from the pixel-by-pixel segmented images to a second neural network as input variables; and
wherein the second neural network is configured to determine at least one class, from a plurality of contamination classes, from the one or more features extracted as an output variable.

8. The self-propelled harvester of claim 7, wherein the at least one neural network is configured to segment the one or more images received from the camera system pixel-by-pixel in that a respective class is assigned to each pixel, which is defined as a property saved in a memory unit.

9. The self-propelled harvester of claim 7, wherein the plurality of contamination classes comprise: a property; and the property harvested material.

10. The self-propelled harvester of claim 7, wherein the one or more features saved in the memory unit to be extracted from a feature group comprise: segmentation ratio; number of polygons; average polygon size; standard deviation of a polygon size distribution; smallest polygon size; and largest polygon size.

11. The self-propelled harvester of claim 10, wherein the plurality of contamination classes comprise soil; and
further comprising a contour search algorithm configured to determine segmented pixels in the polygons of the contamination class soil.

12. The self-propelled harvester of claim 7, wherein the second neural network comprises a neural network with an input layer, a hidden layer, and an output layer.

13. The self-propelled harvester of claim 7, wherein the at least one neural network is configured to evaluate at least three consecutively received images of the flow of harvested material for the determination of the contamination class from the plurality of contamination classes; and
wherein the at least one neural network is configured to output a weighted average value indicative of weighting of the at least three consecutively received images.

14. The self-propelled harvester of claim 13, wherein one of the at least three consecutively received images of the flow of harvested material for which the contamination class is to be determined is selected; and
wherein the one of the at least three consecutively received images selected has a higher weighting than at least two other images of the at least three consecutively received images when averaging.

15. The self-propelled harvester of claim 1, wherein the flow of harvested material is a green forage flow of harvested material.

16. The self-propelled harvester of claim 1, wherein the harvester comprises a forage harvester;
wherein the transfer device includes a discharge chute;
wherein the camera system comprises at least one camera positioned on the discharge chute; and
wherein the at least one camera is configured to detect the flow of harvested material flowing through the discharge chute.

17. A method for analyzing contents in harvested material collected by a self-propelled harvester, the method comprising:
using the self-propelled harvester that comprises a front attachment configured to collect harvested material, one or more work units configured to process the harvested material that is collected, a transfer device configured to discharge the harvested material that is processed, and a camera system positioned on the transfer device;
generating, using the camera system, one or more images of a flow of harvested material passing through the harvester;
automatically evaluating, by an image evaluation device using a machine learning algorithm, the one or more images for a proportion of inorganic contaminants contained in the flow of harvested material; and
automatically controlling one or both of the front attachment or the one or more work units of the self-propelled harvester depending on the proportion of the inorganic contaminants contained in the flow of harvested material.

18. The method of claim 17, wherein the image evaluation device comprises a computing unit and a memory unit; and
wherein a plurality of contamination classes are saved in the memory unit and define different degrees of contamination which are dependent on mass content of the inorganic contaminants the harvested material.

19. The method of claim 18, wherein at least one neural network evaluates a plurality of consecutively received images of the flow of harvested material to determine a respective contamination class from the plurality of contamination classes; and
wherein the at least one neural network is configured outputs a weighted average value indicative of weighting of the plurality of consecutively received images.

20. The method of claim 19, wherein one of the plurality of consecutively received images of the flow of harvested material for which the contamination class is to be determined is selected; and
wherein the one of the plurality of consecutively received images selected has a higher weighting than at least two other images of the plurality of consecutively received images when averaging.
